(19) United States
(12) Patent Application Publication
(10) Pub. No.: US 2025/0062366 A1
(43) Pub. Date: Feb. 20, 2025

(54) HDV Ready Electrochemical Electrodes with Novel Composition, Structure and Method of Manufacture

(71) Applicant: BLue-O Technology Inc., Vancouver (CA)

(72) Inventors: Hai Xiong Ruan, Vancouver (CA); Emad Azmy Sultan Girgis, Vancouver (CA)

(21) Appl. No.: 18/684,042

(22) PCT Filed: Sep. 2, 2022
(86) PCT No.: PCT/CA2022/051326

§ 371 Date: Feb. 15, 2024

Related U.S. Application Data
(60) Provisional application No. 63/240,673, filed on Sep. 3, 2021.

(51) Int. Cl. H01M 4/88; C25B 11/054; C25B 11/065; C25B 11/081; C25D 15/00; H01M 4/86; H01M 4/92

(52) U.S. Cl. CPC H01M 4/8878; C25D 15/00; H01M 4/8668; H01M 4/8853; H01M 4/926; C25B 11/054; C25B 11/065; C25B 11/081; H01M 4/8828; H01M 2250/20

(57) ABSTRACT

A novel catalyst layer (CL) composition and structure that provides exceptional durability with sustained catalytic performance for intended heavy duty vehicle (HDV) application. This inventive composition and structure of the CL includes an internal composition composed of binder-coated nanoparticles, binder-free catalyst nanoparticles and orderly electric, ionic, gas and liquid pathways; a multi-layered structure of different packing densities among multiple sublayers; and external patterning of an outer surface of the CL. Extended durability and catalytic performance of the CL is achieved, and through use of the inventive CL, a novel solid-state electroplating process is demonstrated to achieve a novel thin-film coated catalyst product. The binder-coated nanoparticles serve as an interconnection base or site to whose binder-coated surface the uncoated nanoparticles are attached in glue-like fashion, achieving an orderly structure in which binder-free catalyst nanoparticles are consistently interspersed between binder-coated nanoparticles and agglomerates thereof.

### FIELD OF THE INVENTION

The present invention relates generally to electrochemical electrodes, such as those used in hydrogen fuel cells and electrolysers, and energy storage devices and more particularly to electrochemical electrodes suitable for fuel cell use in heavy duty vehicle (HDV) applications.

### BACKGROUND

Catalyst Coated Membrane (CCM) composition and fabrication technology is the core component technology for electrochemical products. Several factors restrict the competitors to achieve the best performance over cost products that can meet the long-term clean energy market demand. Ballard Power is one of the leading companies that has developed performing CCM products as well as owns its commercial production process technology. CCM is an electrode comprises two catalyst layers coated on a solid electrolyte membrane. Membrane Electrode Assembly (MEA) is an assembled product of CCM with one piece of gas diffusion layer on each side. The current state-of-art MEAs can produce power density in a range from 0.78 to 1.2 watt per centimetre square with about 0.300 mg Pt/cm². However, through last several decades development, the commercial target of such compact and portal power generators was for passenger vehicles. Since 2015, the electrochemical vehicles market has been shifted to commercial taxi market due to the limitation of the hydrogen refueling stations needed for hydrogen fuel cell (HFC) vehicles. Since 2019, due to heavy air pollution in China, the Chinese government established strong effort to pursue clean energy power generation for transportation vehicles, including public transportation, ships, and trucks. The shift of the market demand for commercial application has put most technology development focus on the cost and durability and performance over all other factors, including powerful zero emission feature of all hydrogen fuel cell (HFC) powered products. Additionally, the whole world has refocused its product demands on the same trend of light duty vehicle (LDV), medium duty vehicle (MDV), and heavy-duty vehicle (HDV) markets. It is apparent that such commercial sectors must adopt such zero-emission technology first in order to reduce greenhouse gas (GHG) emissions. as these sectors are heavy GHG producers compared to passenger vehicles.

To meet all commercial HDV application, durability and cost have become the critical economic factors for the HFC market. Migration of passenger vehicle HFC powertrain for HDV application is not a long term and durable solution. Therefore, the development of highly durable and cost effective HFC products is highly desired. For any electrochemical stack to reach over 25000 hours in normal operation condition with high power density, comparing to 5000 hours for passenger vehicles, the core component of the fuel cell (FC) stack, CCM or its MEA, must reach or exceed such durability. In public domain, there is not any such technology or product disclosed that can meet the current market need, even with sustainability of cost and performance before this application.

Schuler and others [Ref 16] stated, in their 2019 publication in the Electrochemical Society (ECS), that the Catalyst Layer (CL) structure bears much importance to enable a durable and highly catalytic electrode. In their paper, they theorized various components that impact the power density within the CL structure made by well known methods. In addition, they measured and identified various sub-resistance of the components of CL. Among them, their results indicated that Knudsen and ionomer transport resistance were the major CL resistances, followed second by interfacial resistance. Through their systematic study, they concluded that the CL design and fabrication process also have large impact for the through-plane CL resistance even at the same CL thickness. Therefore, making a durable and highly catalytic active CL proven very challenging in science and engineering.

Since MEA is the core component of hydrogen based electrochemical stacks, its CL degradation has become a critical difficulty for the market expanding and rising.

Hu and others in the [ref 9], summarized three key durability degradation mechanisms of Polymer Electrolyte Membrane Fuel Cell (PEMFC) that shorten its lifetime under typical driving conditions: (1) durability degradation in start-up and shutdown conditions; (2) durability in dynamic load cycles; and (3) durability of PEMFC in idling and heavy load cycles. In the first mechanism, it was pointed out that a high reversal potential of 1.6 V produced at the interface from unprotected start-up cause the catalyst carrier corrosion, which will lead the Pt-based catalyst particles to agglomerate and become bigger. The direct consequence of such step will cause the loss of Electrochemical surface Area (ECSA) of the catalysts in the CL, which is a key factor of the degradation of durability. In the second mechanism, it was found that the majority of performance loss of the PEMFC under Accelerated Stress Test (AST) [Ref18] cycles, was due to Pt/C anode materials degradation. From various publications, the growth and agglomeration of Pt nanoparticles were observed. In addition, membrane thinning, and catalytic layer decay were two primary factors for permanent performance degradation under this accelerated degradation test [ref 5]. In its publication of [Ref 5], after 370 hrs testing, it was found that Pt-based catalyst uniformity was changed and some migrated into the membrane. CL appeared with more cracks and gaps. The microstructure change was concluded based on its correlation to the loss of ECSA and the increase of the membrane resistance and charge transfer resistance. Further, regarding the third mechanism, it was found that many scholars had documented that when electrochemical operated at high output power, fuel cell performance will decay faster. Jian Xie [ref 1] documented when the current density is greater than 0.8 A/cm², the FC output voltage degradation accelerated significantly. Hu's findings in 2018 [Ref 10] were mostly in agreement with what Bruijn summarized in 2008 [Ref 3] in his section of 4.2 mechanisms of electrode degradation. De Bruijn [Ref 8] summarized that the key factors include the loss of ECSA, the support carbon corrosion, the oxygen evolution due to reverse potential, and other degradation factors including ionomer, Gas Diffusion Layer (GDL), and (Macro Porous Layer) MPL.

De Bruijn further concluded that the dominant causes of degradation in a stead state under constant load conditions is the decrease in water removal capacity of the GDL. Other factors include (1) membrane degradation that causes the short lifetime; (2) Pt particles growth results in a steady decrease in cell potential. However, Bruijn also indicated that under AST or automotive load cycling, start-up and shutdown, low humidification, and fuel starvation, the degradation rate can increase by orders of magnitude. Through the years of R&D, these difficulties have been at least partially overcome by energy management, utilizing system controls like purging with air to remove residual hydrogen etc. However, no apparent methods or compositions or structures of CL have shown its ability to overcome such existing difficulties to display a high power over exceptional long durability for much desired HDV application. HDV AST protocol was published by the United States Department of Energy (DOE) in November of 2019.

Rodney Burrup [Ref 5] in 2020 pointed out in his paper titled “Recent developments in catalyst-related PEMFC electrochemical durability” that catalytic particles growth and loss, and the corrosion of the support, are the critical factors for the degradation of the MEA. It was also found that electrode layer morphology plays an important part in the performance and durability of fuel cell. Finally, Burrup concluded that Degradation of Pt and Pt-alloy catalyst nanoparticles and the cathode electrode structure continued to be major concerns for hindering the commercialization of PEMFCs for transportation applications. In addition, catalyst and support ASTs will continue to provide useful information on the relative stability of material and benchmarks for catalyst material-based solution that does not require system mitigation strategies to achieve adequate lifetime.

Schuler [ref 16] identified various sub-resistance components in the CL. However, he did not provide a solution to solve the problem, and instead more studies were required.

It is one objective of the present application to overcome the identified sub-resistance contribution factors and improve performance and durability through provision of novel CL compositions, novel CL structures, and/or combinations thereof.

Another objective is the provision of a novel durable catalyst product that minimizes or mitigates the dissolution and/or growth thereof.

In another field, utilization of durable and cost-effective supported catalyst in electro-chemical reactions has been researched and developed extensively over the last few decades. The driving force is to reduce the cost of the clean energy products with extended lifetime. Many innovative structure and shapes of active catalysts on support or by themselves were developed and tested. However, many of them suffered terrible short life span in 25 to 50 cm² area MEA testing. Many of them could not even make a good MEA due to the extreme difficult of homogenization of such catalysts or supported catalysts. Some of extremely active catalysts suffered fast deterioration due to the unstable structure, including the cage structure, and de-alloyed skeleton structure. Such structures cannot provide a stable activity due to the rapid change of their initial structure. It is an undoubtedly scientific fact that electrochemical catalytic reaction in fuel cell application involves intensive reaction of the catalyst.

Ruan published a plate shape nanocatalyst on support in 2011, in which such plate shaped nanocatalysts showed exceptional durability comparing to other commercial catalysts in the same category. However, the deterioration of the activity due to the loss of ECSA was unavoidable, even with a much slower rate.

Accordingly, another objective of the present application is to address the ECSA loss and resulting deterioration seen in the prior art.

It is well known that a thin film of platinum on a bulk support is very durable for purposes of a fuel cell electrochemical process. However, due to the limited surface area on bulk support, the required amount of platinum is unfeasible for commercial application. This was the core reason for the rising adoption of hydrogen fuel cell technology after supported nanocatalysts were developed and tested. Due to its dramatic reduction of the loading of Platinum, which is the most stable and active material, platinum and its alloy or composite have been extensively researched and developed. Yet, it is impossible to utilize any currently known process (including chemical vapor deposition (CVD), physical vapor deposition, Metal organic CVD, impregnation, and photochemical method and others,) to produce thin film coated nanoparticle support. One core obstacle is that there had no known means to handle each individual nanoparticle for a needed orientation, or a known process that can anchor nanoparticles in suitable position produce a uniform thin film coating on top thereof. In any wet-chemistry, spherical shape catalytic nanoparticles are formed due to the favor of thermodynamic conditions.

Another objective of the present application is therefore the provision of thin film (nanometer thickness or angstrom thickness) coated support nanoparticles for much desired improvement in electrochemical or other catalytic applications.

The technological difficulty of obtaining a high power-density with exceptional durability therefore remains, as demonstrated by the past two decades of research and development and real road testing.

In response to this demonstrated need for novel solutions, which applicant has developed a number of technological advancements, details of which are disclosed herein below.

### SUMMARY OF THE INVENTION

In no particular order, several inventive aspects of the present application are summarized as follows, others of which may also become apparent from a reading of the subsequent detailed description of preferred embodiments.

According to a first aspect of the invention, there is provided a catalytic material thin film coated support catalyst product comprising: (a) nanosized electrically conductive solid nanoparticles, and (b) a thin film of catalytic material deposited on surfaces of said electrically conductive solid nanoparticles.

According to a second aspect of the invention, there is provided catalyst layer composition comprising:
binder-coated nanoparticles coated with a binder as a binding base;
binder-free catalyst nanoparticles attached to at least said binder-coated nanoparticles at the binding base thereof; and
orderly electric, ionic, gas and liquid pathways within the layer that are at least partially defined by interconnections between the binder-coated nanoparticles and said binder-free catalyst nanoparticles.

According to a third aspect of the invention, there is provided a method of preparing a catalyst layer ink mixture, said method comprising:
a) in any order, or simultaneously,
   i. preparing a binder-coated nanoparticles ink solution composed of solid nanoparticles homogenized in a first selected solvent solution, and then mixed homogenously with a solution of a binder that coats said solid nanoparticles; and
   ii. preparing a binder-free catalyst nanoparticles ink solution composed of binder-free catalyst nanoparticles homogenized in a second selected solvent solution, without adding any binder; and
b) slowly adding the binder-coated nanoparticles ink solution from step (a)(ii) to the binder-free catalyst solution from step (a)(i) to allow the binder-free catalyst nanoparticles to attach to the binder-coated solid nanoparticles in a resulting mixture ink solution.

According to a fourth aspect of the invention, there is provided a catalyst layer structure with a multi-layered catalyst layer comprising a plurality of sublayers layered overtop of one another, said plurality of sublayers including:
a) an innermost sublayer characterized by a first material packing density;
b) an outermost layer residing oppositely of said innermost layer and characterized by a second material packing density; and
   one or more intermediate sublayers residing between said innermost sublayer and said outermost sublayer, and each characterized by a respective material packing density that is different from that of said first or second material packing densities.

According to a fifth aspect of the invention, there is provided a method of producing the catalyst layer structure from the fourth aspect of the invention, the method comprising:
a) preparing or obtaining a catalyst layer ink comprising a mixture having at least catalyst nanoparticles, and a binder in a solvent system;
b) depositing a first layer of catalyst material onto a solid substrate at said first packing density by coating said solid substrate with uniform agglomerates from the said catalyst layer ink by controlling a set of process parameters, thereby forming said innermost sublayer;
c) depositing at least one additional layer with a different respective packing density of catalyst material onto said innermost layer by coating thereof with a different size of agglomerates from the said catalyst layer ink through controlled adjustment of one or more of said process parameters, thereby forming said one or more intermediate sublayers.
d) depositing a final layer immediately at another packing density of catalyst material onto said one or more intermediate sublayers by coating thereof with more of said catalyst layer ink under controlled adjustment of at least one of said process parameters, thereby forming the outermost sublayer of the catalyst layer structure; and
e) subjecting the catalyst layer structure to a heated drying process to remove any residual solvent.

According to a sixth aspect of the invention, there is provided an externally patterned catalyst layer composed of the catalyst layer composition from the second aspect of the invention, and further characterized by:
an outer surface having an external pattern formed therein, said pattern comprising:
   a) raised areas in said outer surface of the catalyst layer; and
   b) compressed areas in said outer surface of said catalyst layer that are of recessed relation to said raised areas;
      wherein the raised and compressed areas are laid out in alternating relation to one another over said outer surface of said catalyst layer.

According to a seventh aspect of the invention, there is provided a method of forming the externally patterned catalyst layer from the seventh aspect of the invention, said method comprising, starting with an already fabricated catalyst layer having the catalyst layer composition form the second aspect of the invention, subsequently imparting the external pattern into said already fabricated catalyst layer.

According to an eighth aspect of the invention, there is provided a solid-state electroplating method of producing the catalytic material thin film coated support catalyst product according to the first aspect of the invention, said method comprising: using an electrode whose catalyst layer comprises the electrode catalyst layer composition from the second aspect of the invention and the electrode catalyst layer structure from the fourth aspect of the invention, subjecting said electrode to an electrochemical reaction during which catalytic nanoparticles in the catalyst layer are redistributed to form said thin film of catalytic material on said nanosized electrically conductive solid nanoparticles.

Important factors that affect the PEMFC durability relate heavily to the catalytic materials, their support, and the cathode electrode structure. Disclosed embodiments of the present invention provide unique solutions for optimizing these factors to achieve enhanced performance and extended durability of the resulting inventive MEAs to meet or surpass the benchmarks of LDV, MDV, and HDV application. More particularly, disclosed embodiments include a novel catalyst product with durable thin film coating of catalytic materials, a high performing and durable electrochemical electrode composition and inventive multi-layered structure to produce and sustain such high performance, as well as external patterning to localize the catalytic particles dissolution and redeposition process to provide an excellent redistribution of Pt nanoparticles that provides an exceptional durability of the fabricated electrodes. The disclosed embodiments also disclose a novel process to produce the inventive highly durable and performing Catalyst Coated Membranes (CCMs).

In addition, the inventions disclosed in this application are also suitable for other catalytic processes, including advanced oxidation process for water treatment, industrial fix-bed reactors, high temperature solid oxide fuel cell. The significant improvement of the inventive composition of catalyst layer can be of benefit to all such catalytic processes.

In this application, the term catalyst nanoparticles encompasses both catalytic nanoparticles themselves, and catalytical nanoparticles disposed on support nanoparticles. Support nanoparticles may be conductive or non-conductive nanoparticles. As used herein, nanoparticles refers to particles predominately ranging in size between one nanometer to 999 nanometer.

### BRIEF DESCRIPTION OF THE DRAWINGS

Preferred embodiments of the invention will now be described in conjunction with the accompanying drawings in which:

FIG. 1 is a schematic representation of ionomer-coated catalyst particle clusters in a prior art catalyst layer of a hydrogen fuel cell.

FIG. 2 is a schematic representation of clustered ionomer-coated and ionomer-free catalyst particles in a novel catalyst layer of the present invention.

FIG. 3 is a schematic representation of a membrane electrode assembly of the present invention whose catalyst layers are each composed of multiple sublayers of varying density.

FIG. 4 is chart showing power density measurements of a tested membrane electrode assembly of the type shown in FIG. 3.

FIG. 5 schematically illustrates an externally patterned catalyst layer of the present invention.

FIG. 6 schematically illustrates compression of a membrane electrode assembly (MEA) between two flow field plates to create external patterning in the catalyst layers of the MEA.

FIG. 7 is a scanning electron microscope (SEM) image of an externally patterned catalyst coated membrane of the present invention.

FIG. 8 is an end-of-life (EOL) cross section of the externally patterned catalyst coated membrane shown in FIG. 7.

FIG. 9 is an SEM image of an inventive CL with a densely packed outer layer, showing a smooth surface finish thereof before testing.

FIG. 10 is an SEM image shows a cross-sectional image of an inventive CL after testing, revealing a catalytically concentrated band at a PEM side of the CL.

FIG. 11 is a scanning electron microscopic image of three different areas in an inventive CL whose content in those areas was measured.

### DETAILED DESCRIPTION

In most current CL ink compositions, the composition comprises catalyst nanoparticles, ionomer(s) used as binder, and some conductive nanoparticles. However, the compositions were mainly homogenized together before coating the CL. The key to such ink formulation was reliance on the selection of highly active catalyst nanoparticles, the types of ionomers, the ratio between them, and the selected solvent system, and the homogenizing methods and procedures. The fabricated CLs were to be mainly one homogenous composition layer with similar or identical content through the layer. The resulting CL also required very complicated activation processes and steps to achieve the best performance and needed lifetime. Their remaining challenges are well described above.

In the present application, a complete novel design of the CL composition and layer structure are disclosed. A first portion of nanoparticles are mixed with a binder, for example one or more ionomers. in this step, either electrically conductive or non-electrically conductive nanoparticles can be used. It is preferable to utilize electrically conductive nanoparticles to reduce or minimize its added contribution to electrode resistance, which is critical for high power density applications. If a non-electrically conductive or semi-conductive nanoparticles are used, it is preferable that more binder is used and the amount of non-electrically conductive or semi-conductive nanoparticles is reduced to the minimum to achieve the same goal of minimum added layer resistance.

It is even more preferable to use catalyst nanoparticles with high electric conductivity, which is well known in fuel cell or electrolyzer applications. Therefore, a correct amount of ionomer to catalyst ratio, determination of which is readily within the ambit of one of ordinary skill in the art, is crucial to achieve the desired performance and durability of the fabricated CL. A simple reason for this requirement was that most ionomer is electrically insulative while also ionically conductive. When too much ionomer is used, the ionomer induced resistance increases. If too little ionomer is used, the proton conductivity will be too poor to produce the desired power density.

More importantly, this portion of solid nanoparticles after homogenization and mixing, referred to herein generally as binder-coated nanoparticles, will act as purposeful binding nanoparticles to bind with binder-free catalyst nanoparticles. The utilization of binder-free catalyst nanoparticles that bind on the coated surface of binder-coated nanoparticles is innovative, as such new interconnecting structure reduces ionomer resistance significantly, as the binder-free catalyst nanoparticles can freely react with adsorbed gas molecules while the underlying or adjacent ionomer layer on the binder-coated nanoparticles provides the needed protons, in the case of a fuel cell CL. This composition with binder-free nanoparticles attaching to binder-coated nanoparticles to form an orderly interconnected structure with binder-free nanoparticles is disclosed herein for the first time.

Moreover, the Applicant has found that by adding some binder-free electrically conductive nanoparticles, more benefit is provided, as this adds much more electric conducting pathways to the binder-free catalyst nanoparticles, in case that the binder-coated nanoparticles alone cannot provide the needed electrons to the catalytic particles for the desired electrochemical reaction.

In prior publications, conductive carbon support has been used in some electrode ink in order to reduce the layer cracks of the thin catalyst layer (less than 5 microns) and provide added conductivity. Most Anode CL was decal transferred onto the membrane (CCM) in most commercial process. Adding carbon in the ink mixed with catalyst can provide a smooth CL layer for a better decal transfer. Adding same or similar carbon support into the cathode in PEMFC was not utilized in the prior art however, since the non-active support can reduce the catalytic performance and the added layer thickness can reduce the mass activity due to the increase of water flood in thicker layer. There is conflicting significance when it comes to the cracks in CL: smoothing cracks in the cathode CL is not a critical issue compared to cracking in the anode CL that can cause non-complete transfer of CL to the membrane. As disclosed below, the present invention encompasses a unique composition of CL utilizes bare conductive support in the CL in a manner that is far more beneficial than the potential adverse effect identified in the prior art.

In most commercial or research publications, most catalyst inks were prepared by adding and mixing all solid contents at the same time to form a homogenous solution before coating. The binding between the nanoparticles were random and arbitrary. In the present invention, a portion of nanoparticles are utilized as binding centers to allow more catalytically active catalyst nanoparticles to bind onto such binding centers. This inventive design enables the following additional advantageous properties: (1) it extends the catalytic nanoparticles into the spaces or channels where the gas or liquid will enter, so the catalytic reaction can be enhanced due to this expansion of the catalytic nanoparticles to the reactive spaces; (2) such structure imposes a minimum of ionomer resistance as the proton conductive ionomers are coated on the binder-coated nanoparticles that allow majority of bind-free catalytic particles to react with the incoming fuel molecules and generate electricity; (3) the interconnected binder-free catalyst nanoparticles attaching to binder-coated nanoparticles can allow more gas and/or liquid channels formed among the binder-free nanoparticles or their agglomerates as shown in FIG. 2, which is very beneficial to the desired electrochemical reaction.

As will be appreciated by those of ordinary skill in the art, the inventive CL composition disclosed herein below can work with any catalyst binder, examples of which include cationic ionomer, an anionic ionomer, or even PTFE, in different ink formulations for different applications.

### 1) Addition of Binder-Free Catalyst in the Catalyst Layer

Kocha and others reported in their publication titled “Influence of ink composition on the electrochemical properties of Pt/C” (2012) that in absence of Nafion (a cationic ionomer acting as proton conductor as well as a binder for catalyst particles), Nafion-free Pt/C particles were found to exhibit Oxygen Reduction Reaction (ORR) specific and mass activities that were higher than that Pt/C electrodes with Nafion incorporation by a factor of ˜1.8 in 0.1 M HClO4 electrolytes through RDE experiments. However, in one example, for the electrodes with a semi-industrial size CCM like 50 CM² with average 10-micron thickness or above, without ionomer as a binder in the catalyst layer, the catalysts will disintegrate quickly in a vertical position and redistributed unevenly. Nor without ionomer, the CL with a thickness of 5-micron to 10-micron can conduct protons well under the operation conditions. Many scientific experiments have shown that without a correct amount of ionomer for a CL of a PEMFC, the catalyst coated membrane suffered a terrible performance. In contradiction to this, Applicant herein discloses a composition that includes some ionomer-free catalysts within the CL made electrode(s) that can produce a high power with excellent durability. Disclosed embodiments include mixing of a previously ionomer coated catalyst(s) with ionomer-free catalyst(s), using the same or different catalytic substance, plus optional bare conductive support to fabricate the CL. Such an inventive composition has been found to mitigate greatly several known issues related to electrode performance and durability, including sub-resistances of various component like ionomer, electronic insulation layer of ionomer, non-accessible of gas pathways, etc. The postulated mechanism of such new composition in the CL is depicted in FIG. 2.

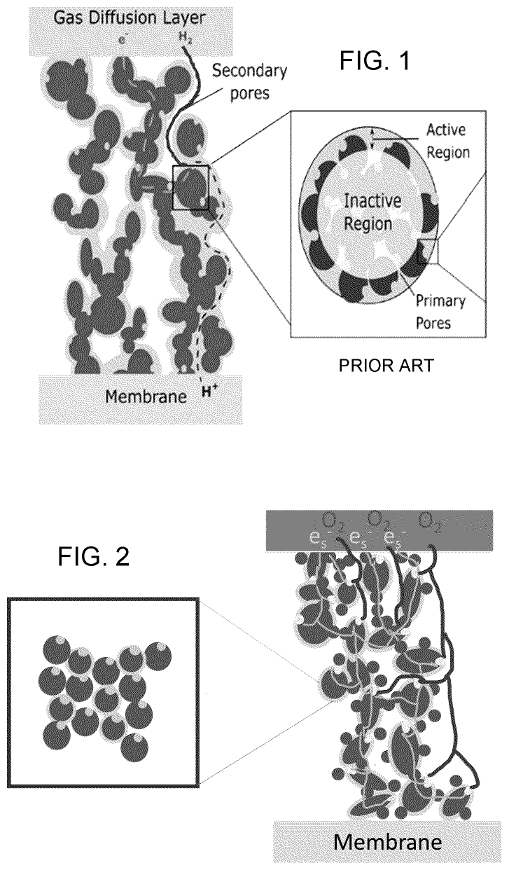

FIG. 1, sourced from Ref 16, shows a conventional CL whose catalytical particles are all ionomer-coated particles, and illustrates limited electron conducting pathway in a light dashed line marked e⁻. Ionomer surrounded voids (pores) are not active unless the reactant gas molecules diffuse through the ionomer layer to the surface of the ionomer-coated catalytical particle. In the partial enlargement on the right of FIG. 1, over about 60+% of the particles are in an inactive region. Thus, many catalyst particles are rendered inactive by the ionomer coating. However, in FIG. 2 shows a particle structure within a CL of the present invention that includes both ionomer-coated and ionomer-free catalyst particles, of which the ionomer-coated catalyst particles are visually distinguishable in the enlargement on the left by encircling of these coated particles in a visually-contrasted outer ring that denotes the ionomer coating around the particle's outer surface. The ionomer-free catalyst particles are exposed directly to the incoming gas molecules, while the ionomer-coated catalyst particles are connected together to form the needed proton conductors. The amount of ionomer used for a first ionomer-containing portion of the CL's overall catalyst content is selected to provide the sufficient proton conducting pathway as well some partially exposed carbon support surfaces to allow the ionomer-coated catalyst particles to connect to each other, or to other particles, electrically to maximize the desired electrochemical reaction.

In the unenlarged right side of FIG. 2, the large dark circles and ovals represent agglomerated catalyst particles that were premixed with a binder, for example cationic ionomer, and hence are shown encircled by the visually contrasted ring around the outside. The dark circles lacking the contrasted outer rings in the enlarged left side of FIG. 2 represent the supported ionomer-free catalysts that lack their own ionomer coating but have stuck to the outer ionomer layer of the agglomerates. A suitable mixing ratio is selected in order to allow the agglomerates to interconnect with each other as shown on the unenlarged right side of FIG. 2. The smaller dark dots represent the added conductive supporting materials (e.g. bare carbon) to provide better electron pathways for enhanced through plane catalytic activity. The lighter toned pathway lines labeled eₛ⁻ represent the electron pathways, while the darker pathway lines labeled O₂ represent gas molecules pathways. Although the picture showed a label of oxygen gas, hydrogen gas or other gas molecules can be used as well.

As Schuler depicted in the left side of FIG. 1, it is not necessary to have ionomer covering all interconnecting catalyst particles. The secondary pores in FIG. 1 allowed more gas molecules to move and reach the catalytical nanoparticles, while the primary pores were responsible for gas permeating through the ionomer layer to reach the catalytical nanoparticles. As the secondary pores exist in a great number in the inventive CL the enclosed space between particles in the enlarged insert view of FIG. 2 for the inventive CL can contain an amount of moisture, which is proton conductive substance as well. In a high temperature fuel cell, water moisture is used as proton conductor in the CL while Polytetrafluoroethylene (PTFE) is used as the high temperature binder. Therefore, the novel CL compositions of the present invention utilize this advantage to promote a potentially less ionomer for a better catalytic performance. Less ionomer within a well-constructed CL will reduce the ionomer induced resistance within the CL, which is in good agreement with the conclusion of Schuler.

In addition, a catalytic solution loaded with a lesser quantity of catalytic particles, or even a non-catalytic support solution containing bare conductive support nanoparticles, can be used in the first binder or ionomer-containing portion of an inventive ink formulation of the present invention, since ionomer-covered catalytic particles suffer more sub-resistances, as reported by Schuler. A more heavily loaded catalytic solution with a greater quantity of catalytic particles can be used for the second binder or ionomer-free catalyst portion of the inventive ink formulation, since the binder or ionomer-free catalyst particles can freely interact with reactant more readily. Selection of a suitable amount of binder or ionomer in order to reach the best performance and durability of the inventive CL is within the ambit of one of ordinary skill in the art.

The binder or ionomer coated surfaces of the binder or ionomer-coated catalysts can be interconnected with one another either in the first portion of ink, or the interconnection can be achieved during mixing of the binder or ionomer-coated catalyst solution with the binder or ionomer-free catalyst solution, or during further mixing with the additional ionomer-free (bare) conducting support to achieve the final ink solution, to achieve the needed interconnection among all of them, including ionomer-covered catalysts, ionomer-free catalysts, and bare conducting support. Alternatively, the interconnection may be achieved during a separate process subsequent to the ink's preparation, for example during coating of the ink onto a substrate to form a catalyst layer, when interconnection between the binder-coated and binder-free nanoparticles can occur as the particles are deposited onto one another, and/or during the solvent vaporization stage performed post-coating.

This interconnection is in a form that binder-free catalyst nanoparticles attach onto the binder-coated nanoparticles, or binder-free conductive nanoparticles attach to the binder-coated catalyst nanoparticles, or binder-free conductive nanoparticles attach to binder-free catalyst nanoparticles, or binder-coated nanoparticles attached to binder-coated nanoparticles.

In the inventive catalyst layer, during the fabrication process, such nanoparticles and/or their agglomerates are packed on top of each other, which allow them to form an orderly layer composition instead of arbitrary composition that was produced from a homogenized ink solution. As shown in FIG. 2, the binder-coated nanoparticles serve as an interconnection base or site to whom at least some of the other nanoparticles are attached at least partly by a in glue-like connection to the binder of the binder-coated nanoparticles. When a sufficient amount of binder-free catalyst nanoparticles attach to the interconnected binder-coated nanoparticles, an orderly structure of nanoparticles is produced in the resulting catalyst layer where the binder-free catalyst nanoparticles are interspersed between binder-coated nanoparticles, and/or agglomerates thereof, to form smaller catalytical bridges therebetween. Likewise, if binder-free conductive support nanoparticles are included in the composition, as described in section 2 below, they are interspersed between binder-coated nanoparticles, and/or agglomerates thereof, to form additional highly electrically conductive bridges therebetween.

The orderly structure at least includes binder-free catalyst nanoparticles directly attached to binder-coated nanoparticles in glue-like fashion at the binder-coated surfaces thereof, and which thereby also interconnect with any other included binder-coated nanoparticles, or their agglomerates to achieve much better electric, ionic, and liquid and gas pathways. In more detail, when conductive support nanoparticles are used, as long as less than entirety of the support nanoparticles' surfaces are covered by ionomer, which is an electrical insulator, the conductive support nanoparticles act as electrical conductors to allow electrons generated from electrochemical reaction to pass or to conduct electrons to the surrounding or adsorbed molecules or ions. When binder-free catalyst nanoparticles contact these at least partially uncoated surfaces of the conductive support nanoparticles, these electrically conductive catalyst and support nanoparticles pass electrons through each other for the intended reactions. In addition, in this invention, when the binder-coated nanoparticles glue the binder-free catalyst nanoparticles together to form agglomerates, and such agglomerates are packed together, an orderly structure of interconnection among the binder-coated nanoparticles and binder-free catalyst nanoparticles is formed. This is unlike homogenized catalyst particle compositions of the prior art, where packing of the homogenized catalyst particles with a binder in the catalyst layer is random or arbitrary with no distinguishable interconnections between individual particles or their agglomerates. In the present invention, binder-coated nanoparticles connect with each other to form a connected network, while binder-free catalyst nanoparticles and/or binder-free support nanoparticles are distributed in attached contact around such binder-coated nanoparticles and their agglomerates, thereby forming an orderly structure of particle interconnections. The contact between binder-free nanoparticles can enhance greatly the electric pathways; while the packing or contact among the binder-free nanoparticles creates much needed and interconnected pores or voids whose interconnected status forms pathways for the gas or liquid to pass through. The connected binder-coated nanoparticles within the packed agglomerates of the catalyst layer form ionic pathways to conduct the protons to the attached binder-free catalyst nanoparticles. A well-connected binder layer on binder-coated nanoparticles among such agglomerates is ensured to enable the maximum electrochemical reaction. These ionic pathways are different from those produced by a single homogenized ink of catalyst nanoparticles, which is random and arbitrary in distribution. Therefore, novel construction of orderly electric, ionic, gas and liquid pathways was achieved by the inventive catalyst layer composition disclosed and enabled herein.

To best of Applicant's knowledge, there has been no prior publication that disclosed a use of binder or ionomer-free catalyst in CLs in commercial CCM, nor a mix of binder or ionomer-coated and binder or ionomer-free nanoparticles, that not only sustains the high catalytic performance (over average 0.7-1.2 w/cm²) but also exhibited exceptional durability to meet HDV application (reach 25000 hrs equivalent). Utilizing binder or ionomer coated nanoparticles as a binding base in the CL structure, adding highly active binder or ionomer free catalytic particles with or without support, and adding multi-purposed bare conductive support all together in the inventive CL composition is first disclosed herein. This novel CL composition provides a better solution to many existing difficulties concerning catalytic performance and durability for PEMFC applications.

In all catalyst ink formulation or processing examples disclosed herein, for the intended electrode catalyst layer coating, all inks may each be made of the same catalyst as one another, from a different respective catalyst from one another, or from a mixture of different catalysts that is a same or different mixture from those of the inks. Selected binder(s) or ionomer(s) is/are mixed at a chosen ratio to carbon in the ink. Then such ink was casted, die coated, or spray coated, or brushed on a membrane to form a catalyst layer.

One additional benefit from the novel composition of the CL is that such notably enhanced electrically conductive pathways of interconnected binder-free catalyst nanoparticles and/or binder-free electrically conductive nanoparticles leads to production of a novel supported catalyst product during an electrochemical process, which is ideal for much-desired electrochemical reactions, including those of fuel cells and electrolysers, or battery applications. This novelty of the resulting supported catalyst product is that a thin film of catalytical material, for example Pt, is coated on conductive support nanoparticles.

2) Catalyst Layer Composition with Additional Conductive Support

In some embodiments, novel CL compositions of the present invention utilize catalytic particles deposited on some conductive support. In order to prevent support corrosion, for example carbon corrosion, and increase through-layer electronic conduction and promote better electrochemical reactions, a highly graphitized conductive support was preferred for the following intended reasons:

### 2.1) Acting as New Catalyst Support

The dissolution and redeposition of catalytic particles like Pt or Pt-containing nanoparticles (NPs) on carbon support particles is well known and has been probed by various scientists and Engineers in the prior art. However, utilizing additional carbon support nanoparticles added to a solution of existing carbon-supported catalytic particles that are already supported on carbon support particles, such that the additional conductive support nanoparticles act as new additional support for the reduced Pt-NPs further deposition, is believed novel, and disclosed herein for the first time. This novel supported catalyst was found to provide added ESCA that can sustain the needed performance.

### 2.2) Acting as Additional Electron Conduction Pathway

The added conductive support or similar (e.g. semi-conductive) support particles provides a better conductivity within the catalyst layer formed with the presently disclosed composition. In all commercial CCM products, ionomer has been used without exception in the ink mixture. Ionomer is an electronical insulator. Electrons are lost when they cannot be transferred out from the producing sites or transfer to the reaction active sites. Adding additional ionomer-free (i.e. bare, uncoated) conductive support enhances and increases the electronic conducting pathway for a better desired electrochemical reaction. This is believed novel, and disclosed herein for the first time.

### 2.3) Enhanced Hydrophobicity

The addition of bare carbon support, or similar conductive support, without ionomer provides better hydrophobic property in the catalyst layer. This is also important to allow the produced or any condensed water to be pushed out from the CL easily.

### 2.4) Acting as a Sacrificial Corrosion Support

It has been documented that catalytical particles deposited on a carbon support leads a slightly higher carbon corrosion rate than the same support without catalytical particles deposited thereon [Ref 2]. Choosing a more corrosive trended support (bare carbon lacking any pre-deposited catalyst at the time of its addition to the ink composition) as the additional support will act as a sacrificial support to mitigate the corrosion of the catalyst support. This was disclosed the first time in this application.

In addition, the additional bare support utilized in select embodiments of the novel CL composition of the present invention enhances the catalyst product durability, as is indirectly supported by Burup's conclusion in his recent review [Ref 5]. As stated therein, the large size of catalytic particles (Ostwald Ripening effect) caused the performance drop due to the loss of ECSA. As the redeposition of reduced Pt on the bare support will create more new ECSA of Pt nanoparticles, this mitigates the loss of ECSA. Comparing to redeposition of Pt on adjacent Pt NPs on the supports, such Ostwald ripening is one of the key factors for the ECSA loss.

Furthermore, when the dissolved Pt ions migrated away from the CL to the GDL or the membrane, this caused irreversible loss of ECSA of Pt. A platinum band inside the membrane close to the CL has been well observed due to the migration effect. Catalytical particles like Pt were observed on GDL mesoporous layer as well. In the present invention, providing bare support nearby locally for the reduced Pt to deposit on minimizes and mitigates such migration.

Also disclosed herein further below is an inventive multi-layer internal structure of CL, which also provides restriction to the migration of dissolved Pt ions and force them to redeposit within the catalyst layer. It is evident from the image in FIG. 8, collected under high resolution Scan Electron Microscopy, that a uniform layer with a more catalytical nanoparticles concentrated band close to PEM side was observed within the cathode CL.

This was the first disclosed and totally different from migration, or irregular redistribution of metal catalytic particles [Ref 1]. Secondly, no metal particles deposited-inside the PEM was observed. This was a direct indication of the exhibition of the compact layer of CL at the PEM side that provided a prevention of further migration of dissolved Pt into the PEM, which was observed by various researchers.

In addition, no prior arts disclosed that the plate shape catalytic structure nanoparticles [ref 19] will maintain plate shape like structure when they grow bigger, nor stated that such particles will remain on the support for a better performance and durability. This invention disclosed that utilizing plate shape structure catalytic particles can further minimize the migration, aggregation, and agglomeration of the growing nanoparticles so that their catalytic performance is maintained. The shape, size and formulation of such plate shaped catalytic particles is disclosed in more detail in Applicant's prior U.S. Pat. No. 9,761,885, the entirety of which is incorporated herein by reference.

Furthermore, the plate shape structure of catalytic particles on the support has shown as an effective factor for uniform distribution of the catalytic particles on the support surface during over 150,000 cycles while produced over 0.90 w/cm² @ 0.585V at the end of life. No previous publications had disclosed that a progressive growth of catalytic particle size on the support would provide such expected performance and durability, but in opposite. The progressive size growth of plate shape catalytic particles was evident in development of the present invention.

Furthermore, even size growth in durability tests were observed, and it is hypothesized that without at least one or more of the additionally disclosed points of novelty detailed below, the large size of Pt-based catalytic particles that would agglomerate and agglomerate together were further mitigated. Worse is that they will migrate from top of the MEAs down to the bottom of MEAs in a vertical mounting direction.

### 3) Solid-State Electroplating Process for Thin Film Coating of Nanoparticles

In this inventive work, it was found that after a period of use of a fuel cell cathode with the of inventively composed CL layer of the present invention, many nanoparticles or agglomerates of nanoparticles were coated with a thin-film of Pt on their top surfaces, as platinum supported catalysts were used. Among these coated individual or agglomerated nanoparticles, some of them were found to be without catalytic nanoparticles on the support. Some others were found to have some catalyst nanoparticles situated under the Pt thin film. As is well known in the public domain, a continuous Pt thin film has negligible deterioration of catalytic activity. With this in mind, this novel solid-state electroplating process can be exploited and further developed to produce such inventive new catalysts.

In FIG. 10, the white nanoparticles were observed across the layer thickness, and more were observed at the interface between the membrane and the CL. These white spots were analyzed by Electron Diffraction X-ray spectroscopy and proved to be Pt rich particles.

The observation of such Pt thin film coated particles across the CL indicated the effectiveness of the well-connected electric pathways and proton conduction pathways. An optimized composition can lead to a further advancement of this novel solid-state electroplating process. With continued reference to FIG. 10, it was also observed that such thin film was coated on agglomerated particles as well, and that such thin film was also coated on top of some existing catalytical nanoparticles on the surface of the support.

With existing scientific knowledge in the field of liquid state electroplating, most transition metals can be electroplated on some conductive substrates if the known ionic complex(es) is/are available. Solid-state electroplating utilizes the same mechanism by reducing nearby metal ions onto the cathode material surfaces without immersion in a liquid process phase. Therefore, many metals including chromium, iron, copper, nickel, cobalt, yttrium, zirconium, niobium, molybdenum, ruthenium, rhodium, palladium, silver, indium, tin, barium, hafnium, tantalum, rhenium, osmium, iridium, platinum, gold, lead, bismuth, lanthanum, samarium, can be used in this process to produce thin film catalytic material coated nanoparticles.

Several key differences between the existing electroplating methods and the inventive solid-state electroplating disclosed herein include:
(a) solid-state electroplating does not require a liquid electrolyte or plating metal ionic compound in the electrolyte;
(b) solid-state electroplating coats nanoparticles instead of a bulk object;
(c) solid-sate electroplating occurs within the cathode, in which the dissolution of plating metal and reduction of the plating metal ions happens at the same time, which is unlike most commercial electroplating, where metal transfers from anode to cathode, or from the solution to the cathode;
(d) solid-state electroplating does not produce waste liquid, or toxic waste gas or solution.

In one embodiment of this inventive solid-state electroplating process, an inventive electrode with the above described composition and below described layered structure was fabricated. This CCM was assembled with GDLs and installed in a cell fixture. Under a humidification condition and elevated temperature between 60-85 Celsius, the cell underwent cyclic voltammetry cycling between 0.6V and 0.95V while hydrogen was used on the anode and nitrogen was used on the cathode. This duty cycling was continued while monitoring the ECSA change of the CCM. Once the ECSA reached a stable value, the solid-state-electroplating process was considered complete. Due to the nature of the nanoparticles, in some experimentation, some plated nanoparticles were observed early, for example after approximately 65000 cycles, prior to the “completion” denoted by the stabilization of the ECSA. Through electron microscopic investigation, many metal plated nanoparticles were observed.

It is highly possible to produce such novel Pt-thin-film-coated, or other similar catalytic material(s) coated nanoparticles by way of this inventive solid-state electroplating process. According to the inventor's best understanding, if the cycling potential is increased to 100 mV/second, or even 200 mV/second, the deposition process is expected to speed up significantly. Thus, a significant amount of such novel Pt-thin-film coated nanoparticles are expected to be producible in a large quantity.

This solid-state electroplating for thin-film coating can be extended to other applications by utilizing the inventive catalyst layer composition in those other applications. Advantages of this novel process are set forth in the following non-exhaustive list:
a) It enables many other metallic thin-film coated nanoparticles to be produced for various applications. For example, it is highly desirable to produce Iridium thin-film coated support catalyst. As iridium is the most expensive catalyst for water electrolysers for green hydrogen production, reduction of the loading of Ir is significantly beneficial.
b) The inventive process accomplishes what was previously believed impossible: to coat nanoparticles with a thin layer whose thickness may range from a few angstrom to a few nanometers on the outer surface of the nanoparticles. If the process were to be well developed and controlled, the thickness of such coating can be controlled and defined. As with earlier development of liquid phase electroplating, the novel process has large future potential for many new and novel materials development and production.
c) One notable advantage of this solid-state electroplating process is also its zero emission status and much reduced or negligible waste and/or harmful chemicals, compared to that of current liquid electroplating, in which the waste chemicals and pollution are unavoidable.
d) This novel solid-state electroplating process can be amplified easily based on known scientific and engineering knowledge. With a large and fast electrification process, the production of thin-film coated nanoparticles as support novel materials is highly feasible.
e) In this invention, thin film of catalytic material was produced on the support nanoparticles by a fuel cell reaction process. However, it also can be done with an electrolyzer, in which case the plating materials can be placed in the anode side. Catalytic material involved in the oxygen reduction process will go through dissolution and redeposition process. Utilizing the inventive layer composition, this will allow the catalytic metal ions to migrate to the conductive support surfaces and be reduced when the electrons were presented.

It was found that catalytic metals had a much higher content within the innermost sublayer than in the other sublayers. However, at this stage, the exact mechanism of such migration was not known. A possible reason could be that within the compact packing density of the innermost sublayer, the contacts between conductive nanoparticles and nanocatalysts were greater than in the more loosely packed intermediate sublayer. Under a constant operation, the concentration gradient of metal ions within the catalyst layer during the process could be the main force to drive more metal ions to the depleted area where they were reduced in the innermost sublayer more quickly than in the intermediate layer.

Combining the public knowledge of electroplating under electrolysis process, this inventive solid-state electroplating can be conducted under a forced current condition to allow the said process to be much more efficient.

Separation of thin film coated nanoparticles from non-coated or partially coated nanoparticles could be done by utilizing capping ligands to remove non-thin-film coated nanoparticles. Or vise versa, to remove the thin-film coated nanoparticles by washing, centrifugation, and others.

The inventive CL with binder or ionomer-coated catalyst, binder or ionomer-free catalyst, and added bare (binder or ionomer free) conductive support provides many more electron pathways, gas fuel pathways, and accessible catalytic particles pathways. Such significant enhancement of pathways provided the enhanced catalytic activity and reduced dramatically all sub-resistances identified by Schuler. It also is predictable by any skilled in art that reduction of such CL, equally reducing the catalytic particles like Platinum loading, is highly feasible. At the same time, the reduction of catalytic particles in the CL will also reduce the CL thickness, which is also favourable for better mass activity as it mitigates the water flooding issue.

### 4) Multi-Layered Catalyst Layer Structure

Another objective of this invention is to reduce the migration of the dissolute catalytic ions. In conventional CL fabrication processes, there is no purposefully resulting structure particularly useful for mitigation of catalytic particle ions. In prior fabrication of a two-layer CL of a cathode, the packing densities among the two sublayers of the CL were similar to one another. In the present invention, different sublayers with different sublayer packing densities are instead employed. In the particular embodiments of the present invention, at least three sublayers of varying packing density are constructed in the inventive CL.

As used herein, material packing density is defined as the number of solid particles, which include individual particles and agglomerates, in a given volume. Smaller particle size thus equates to a higher material packing density compared to larger particles for a given volume of material.

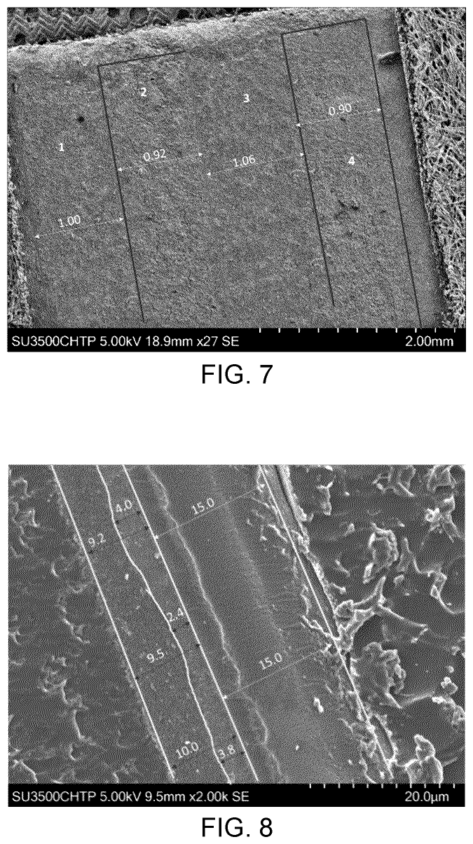

In one embodiment, the inventive multi-layer CL structure consists of three sublayers: (1) an innermost layer that lies on top of the membrane, and has a compact layer structure with a high packing density of nanoparticles or their agglomerates; (2) an intermediate layer that is prepared on top of the innermost layer, and has a loose packing structure with a low packing density with large nanoparticle agglomerates; and (3) an outermost layer that is fabricated right on top of the intermediate layer. This outermost layer utilizes smaller agglomerates of nanoparticles to produce a compact layer with a smooth surface (see FIG. 7).

The purpose of the innermost layer with a high packing density has two main purpose: (1) to create an intact interface to prevent delamination of the CL from the substrate, for example a PEM, which otherwise may be a concern due to its inclusion of binder-free conductive nanoparticles and/or binder-free catalyst nanoparticles (large agglomerates will create pores existing between the membrane and the sublayer, and such air pockets are undesired as they increase the local flood and interfacial resistance); and (2) to create a buffer zone for high concentration of protons transferred through the membrane. The purpose of this buffer zone is to allow a concentration gradient to be produced and to allow a high concentration of protons to stay longer in this zone for the intended electrochemical reduction reaction in the CL.

The purpose of the intermediate layer is to fully utilize the binder-free catalyst nanoparticles to improve the much-desired reduction reaction, particularly in the case where the CL is the cathode of a fuel cell. Therefore, a I a large thickness of this layer is preferred to be fabricated for high current density applications.

The purpose or advantage of the outermost layer is twofold: (1) to smooth out the rough surface of the more loosely packed intermediate layer, as this outmost layer contacts the GDL directly, and a smooth top surface provides better interfacial conductivity, as air pockets or gap, or dents are drawbacks to the performance of the CL; and (2) to create a compact layer to prevent the binder-free nanoparticles being lost or flush out by produced water under high current operation. In some embodiments, the nanoparticle size of the innermost layer and the outmost layer is much smaller than that of the intermediate layer. In one particular non-limiting example, the former has an average nanoparticle size of no more than 150 nm, while that of the intermediate layer ranges between 100 to 500 nm. The small average size of nanoparticles in the innermost sublayer of the CL was engineered by controlling different coating process parameters, while the bigger size in the intermediate sublayer was achieved in controlled fashion by varying some of those process parameters.

In one example, on top of a membrane, which may be a proton exchange membrane (PEM), an anion exchange membrane (AEM), or a hydrocarbon membrane (HCM), or on top of a mesoporous layer of GDL, a first sublayer with high packing density of solid content of CL was prepared. Then, a loosely packed second sublayer of solid content with larger solid particles was deposited. After this second sublayer, a smooth top sublayer was deposited with smaller solid particles to create a smooth outermost sublayer. The intent behind a compact sublayer at the bottom of the CL (i.e. close to the membrane) is to provide a purposefully configured layer to slow down the migration of the catalytic particle ions, and further cause these catalytic particle ions to deposit on the small agglomerated particles that comprise binder-free catalytic particles. If Pt is used as the catalytic particles, Pt nanoparticles are excellent reducing agents to reduce the Pt(2+) ions. With some or minimum cross over hydrogen, the dissolute Pt(2+) ions could be fully reduced in the compact layer, either on surface of the pre-existing catalyst nanoparticles, or on the surface of the bare conductive support.

A clear observation of some fully Pt-coated nanoparticles at the boundary between the CL and the membrane, as well as within the CL, in FIG. 10 is strong evidence of the unique result from this inventive multi-layered structure of the inventive CL. The white colored particles are the individual particles (sized from 30 to 80 nm) and agglomerated particles fully coated with Platinum in this imaged sample. The uniform brightness of catalyst particles indicates that their surfaces were fully coated with platinum under SEM imaging. Some pre-existing nanoparticles were present under the thin coating. Undoubtedly, such platinum thin film fully coated catalyst particles were the first time produced and disclosed in this invention. These novel catalyst particles not only were produced at the interface, but they were produced within the innermost layer of the inventive CL (in the vertical direction of the FIG. 10 image, which shows the cross-section of an inventive CL after more than 100,000 cycles of HDV MEA protocol, which was published by Department of Energy of United States).

From the Electron Diffraction X-ray spectra, a uniform high content of catalytic particles in the innermost sublayer of the CL in FIG. 8 was detected. The catalytic particle content of this innermost sublayer was almost three time of that in the adjacent sublayer. These data indicate that the inventive multi-layered structure successfully mitigated the migration of platinum ions within the innovatively composed CL. The well connected electron pathway was evidenced by the deposition of fully coated platinum catalyst nanoparticles and agglomerates in the said CL, since Pt(2+) ions were reduced whenever electrons were presented. With binder or ionomer coated catalysts, the Pt(2+) ions were migrated into the membrane and were reduced within the membrane to cause a permanent loss of ECSA. The crossed over hydrogen was another reduction source for reduction of migrating Pt(2+). Hydrogen cross over in the PEM, as well documented in the literature.

This inventive multi-sublayered CL structure also prevents detachment of the non-binding catalyst particles from the catalyst layer electrode that can cause significant CL structure change and catalyst peeling off during operation, a careful designed sandwiched structure composed of multiple layers of varying material density was invented, and is disclosed herein as follows. In this inventive multi-sublayered CL structure, two compact sublayers were fabricated on the top (i.e. outermost region furthest from the membrane) and at the bottom (i.e. innermost region closest to the membrane) of the catalyst layer, while a middle sublayer situated intermediately of the top and bottom sublayers was filled with large agglomerates of nanoparticles, thus having a lesser material density than the top and bottom sublayers.

The dense or compact sublayer on the top or the bottom of the CL was fabricated by utilizing smaller particles of solid content of catalyst ink to form a compact layer. The layer thickness can vary based on the layer structure design. The middle layer was formed with large, agglomerated particles that created more pores, resulting in a more loosely packed sublayer structure than the top or the bottom sublayer.

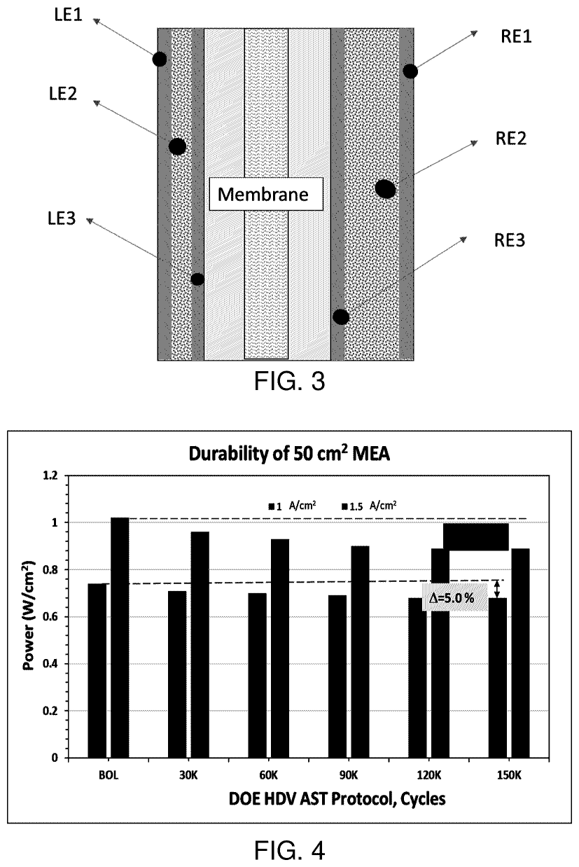

Referring to FIG. 3, LE1, LE2, and LE3 are the outermost, intermediate, and innermost sublayers, respectively, of the left electrode of a novel MEA of the present invention; while RE1, RE2, and RE3 are the outermost, intermediate, and innermost sublayers of the right electrode of the MEA, in which the two electrodes are separated by a membrane. Outermost and innermost sublayers LE1 and LE3 of the left electrode are the compact layers of greater material density, while intermediate sublayer LE2 is a more loosely packed sublayer of lesser material density than LE1 and LE3. Likewise, outermost and innermost sublayers RE1 and RE3 of the right electrode are the compact layers of greater material density, while intermediate sublayer ‘RE2 is a more loosely packed sublayer of lesser material density than RE1 and RE3.

From the experimental results, at the end of life (EOL), the CL thickness still remained within average 90+% of the original CL thickness. This sustained structure is crucial for a needed lifetime with high performance. Applicant believes that one of the key contributors is such inventive multi-layered structure design, particularly when mingled with the inventive CL composition composed of binder-coated catalytic particles, binder-free catalytic particles and additional bare (ionomer-free) conductive support.

The higher catalytic performance over the DOE HDV AST (2019.11) [Ref 18] testing period was clear evidence of success of this structure [see FIG. 4]. The improved and sustained high power density establishes that such an inventive engineering of the electrode layer structure was of great value for industrial practical application.

Furthermore, within the CL, a greater number of packing-density-distinct sublayers formed with same or different catalyst as one another can be utilized, for example substituting two or more intermediate sublayers for the illustrated scenario of a single intermediate sublayer like LE2 or RE2. For instance, of the middle of the CL can be composed of two different loosely packed catalyst sublayers, including that one is more durable catalyst layer, while the other is a more catalytic active layer. Such structure can provide an increase of catalytic performance with much extended durability, as the inventive composition will provide the same functionality for the retaining the catalytic particles during their dissolution and redeposition route.

Ballard Power disclosed a multilayer electrode to enhance the catalytic performance. Basically, they developed a two-layered structure for cathode CL. One layer composed with Pt-only supported catalysts for the needed durability. While the other composed of Pt-Alloy supported catalysts to provide high catalytic performance. However, no free carbon or ionomer-free supported catalysts were disclosed in those layers. Nor, did they disclose utilization of any artificial patterning of the fabricated catalyst layer. Nor did they disclose the inventive ink formation and the related catalyst structure sublayers to provide sustained durability. Literature [Ref 20] disclosed to add black carbon particles in the anode layer to minimize the cracks of the layer due to its thin thickness. However, it did not disclose addition of ionomer-free catalysts in a different step, nor did it disclose utilization of a sandwiched/sublayered structure of the CL. Based on the known science, platinum thin film has been found to have minimal deterioration over as much as 10 years for a satellite fuel cell battery application. These platinum film coated catalyst particles in the present invention can achieve the same durability and performance as well.

When the disclosed composition of catalytic particles is used to form a correct internal connection between all the catalytic particles, a stable catalytic performance can be produced, as supported by the known science, which also supports that the minimization of loss of catalytic active surface area can lead to the sustained catalytic performance over time. When the condensed catalytic particle layer is optimized, it can reach a stable catalytic performance based on the formation of connected catalytic particles. This is fully supported from the known science that a platinum continuous film shows a minimum to negligible decay of performance over the time.

In support of the utility of the present invention, a 50 cm² active area sized MEA with the above disclosed multi-layered CL structure was fabricated by a coating means. It was activated and subjected to test under US DOE HDV AST protocol published in November 2019 (Ref 18).

In another application, for example in advanced oxidation process for water treatment, the above disclosed catalyst layer composition can be coated on some absorption substrate like activated carbon. This composition formed surface layer structure will allow the active catalyst nanoparticles like Fe3O4 to extend into the water stream and capture more pollutants like phenol complexes. Not only will such composition save the loading of the active catalyst nanoparticles, but also will enable a fast reactivation process by reacting with some selected oxidant, such as hydrogen peroxide, to cleave the adsorbed pollutants on the surfaces of the catalytic nanoparticles or adjacent sites. The distinct difference of this inventive composition comparing to catalytic particles deposited right on the surface of the same activate carbon substrate is that its composition enables significant capture of pollutants by its extended networking structure on the surface with same or even less needed active nanoparticles.

Particularly in view of this foresight into different potential applications for the inventive subject matter disclosed herein, it will be appreciated by those of skill in the art that the inventive catalyst layer composition can be utilized not only for an electrode catalyst layer, but can also be applicable to other catalytic reaction aimed processes.

### 5) Post Fabrication Patterned Catalyst Layer

Also disclosed herein is an post fabrication of a fabricated inventive catalyst layer in order to mitigate further some degradation factors known in the public scientific domain, including the migration of dissolved Pt ions to membrane, to the GDL, and re-deposition on the catalysts to form bigger catalytic particles which form a depleting zone from top to the bottom along the vertical position as most MEA products are assembled in vertical fashion, which allows the produced water to drain out easily. This artificial patterning changed the catalytic particles dissolution-redeposition pathway across the whole CL area.

Burup and others (Ref 5) found that one key factor affecting the MEA performance and durability degradation is the cathode electrode structure and electrode layer property including the composition of the materials in the ink and the formed layer structure itself.

Byron Gates [Ref 17] disclosed creation of patterns on the CL in order to improve the performance. However, the patterning of the CCL (Cathode Catalyst Layer) or ACL (Anode Catalyst Layer) did not show exceptional performance at all, as its current density was at 1.5 A/cm\hat{ }2 at 0.6 V under hydrogen and oxygen gases, which is almost 1.5× less than normal CL without patterning under the same testing conditions. It is noted that the catalytic activity in hydrogen and oxygen conditions can provide up to 2 to 3 times performance than that tested under hydrogen and air conditions. Simply due to the low oxygen content in air, about 21%, while in pure oxygen gas, it is near 100% oxygen. No durability data was reported. More difficult is that Gates utilized nanolithography technology that is expensive and hard to scale up for commercial application. In public domain, most Pt/C non-patterned CCL can reach over 2.0 A/cm\hat{ }2, or even 2.5 A/cm\hat{ }2 at identical or better voltage under hydrogen and air condition.

The shortcoming of such design and fabrication is that there were many small pockets of the holes can cause a local flood during moderate or high current density, which could be the cause of its poor performance. As such patterning over the whole area of electrode means that many of the patterns were under the land, this patterning would not mitigate the known degradation factors effectively due to accumulation of water. Nor their experimental results provided any indication to such degree. However, based on its fabrication process, it was fundamentally different from the presently disclosed artificial pattering of the inventive CL. More, their process is very costly and not for commercial production. But the presently disclosed artificial patterning is extremely cost effective as it can be done by simple mechanical assembly means.

As migration of dissolved Pt (2+) ion and uncontrolled redeposition of Pt is known to occur on downward portions of current commercial MEAs, a local restriction of such movement and/or locally regulated redeposition pathway may provide excellent mitigation effect and reduce the degradation of the MEA. Experimental results from the inventive post patterning of the presently disclosed CL strongly supports this theory.

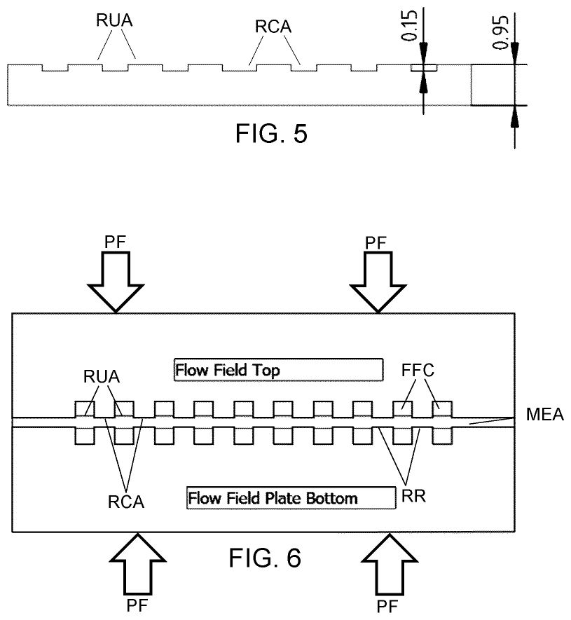

In the present invention, the externally patterned structure of the CLs is not created during the fabrication of the CLs to prevent any discontinuity of the catalytic reaction in the CL, but is instead imparted after the said CL is already fabricated, using external means to create external patterning of the CL. With reference to FIG. 5, this pattern includes an alternating layout of raised/uncompressed areas RUA and recessed/compressed areas RCA across the outer surface of the CL (i.e. the surface thereof situated opposite the membrane). This external patterning was invented with the intention of localizing the catalytical particles dissolution and redeposition process, which mitigates the migration and aggregation of catalytic particles so that the reduction of the electrochemical area of catalytic particles is reduced or significantly smoothed.

In more detail, with reference to FIG. 6 where an MEA with two electrode CLs on opposing sides of its membrane is shown in combination with two flow field plates on opposite sides of the MEA in facing relation to the two electrode CLs, the raised/uncompressed areas RUA of each CL are located in the gas flow-field channels FFC of the respective flow field plate, while the recessed/compressed areas RCA of each CL align with raised ribs RR of the respective flow field plate that separate the flow-field channels FFC from one another. The raised/uncompressed areas RUA have more catalytic particles to react with the diffused gas reactants, which in turn produce more catalytic activity. Even with a recess depth measuring only about 10 to 15% of the overall thickness of the CL layer, this external patterning has shown to achieve a significant increase in the catalytic performance, along with a significant durability increase. A possible explanation for the extended durability could be that the inventive CL patterning localizes the dissolution and the redeposition of catalytic particles in the repeated pattern areas. When the same amount of catalytic particles are in the recessed/compressed areas CA and the raised/uncompressed areas, the localization of those areas to allow the dissolution-and-redeposition process produced a uniform catalyst density during the operation, instead of a sloped catalytic density across the CL.

Unlike other conventional assembly, when there is no such post patterning of the CLs, the dissolution and redeposition of catalytic particles in the whole CL created a slope of Pt concentration over the entire CL with a fashion from a thin top (less particles) to a piling up bottom (more catalytic particles). Although it is impossible to stop this dissolution and redeposition effect, utilizing such inventive patterning of CL, their deterioration effect was greatly mitigated and reduced.

This feature is distinct and very beneficial for a high performance with long durability power generation. As a result, such patterning during assembly of an MEA created a uniform Pt concentrated band near the RIM side, instead of a slope. The formation of such a uniform layer of higher Pt concentration band could be due to the following factors: 1) The localized Pt dissolution and redeposition effect as described above; and 2) The incorporation of the additional free carbon particles. The bare carbon particles can be utilized as additional support for the reduced Pt redeposition. This function mitigated greatly the growth of catalytic particles upon the new reduced and deposited Pt nanoparticles. This may also well explain why the ECSA decay was much slowed down due to the newly formed supported catalysts.

Secondly, the recessed/compressed areas RCA located under the raised ribs RR of the flow field plate will allow electrons to access to more adjacent catalytic particles in side walls of the CL that transition between the recessed/compressed areas RCA and raised/uncompressed areas RUA, or will allow the electrons to be released quickly to or from the conducting flow field plates. This is because if the conventional surface contact is between raised ribs RR and the conductive CL, then this inventively patterned CL structure will allow the electrons to be released from the flow field channel walls of the flow field plate to the neighbouring side walls of the CL. For ORR, the added access of the electrons will enhance the ORR reaction rate, even a better utilization of oxygen as the reactant. A correct compression is also beneficial to reduce the contact resistance. For a heterogenous multi-phase reaction, this feature provides better reaction pathway to sustain and enhance the power generation performance.

In the post fabricated non-limiting example shown in FIG. 5, the normalized overall CL thickness was 0.95, and the compressed depth of the recessed/compressed areas REA was 0.15. Beneath the floor of the recessed/compressed areas REA, the material density of the CL layer is more compressed than it is under the raised/uncompressed areas RUA, where the CL's material density is more loosely packed.

These patterns were observed in the inventive CL shown in FIG. 8 where, the thickness of the CL at an RCA compressed under a land of the flow field plate was seen to transition from a relative thickness of 9.2 micron to a greater thickness of 10 micron, which is a typical thickness of a targeted cathode CL, in a direction moving outwardly toward an adjacent RUA. It is pointed out that the SEM imaging was done after the external pressure was removed. Due to image area size constraints of the SEM instrument, observation of sufficiently small-scale thickness differences (e.g. 0.8 to 1.5 microns) within an area sufficiently large (e.g. 2000×1000 micron) to encompass the full RCA/RUA transition was not possible. The selected area imaged and shown in FIG. 8 therefore shows only a partial fraction of the transitional area between an RCA and neighbouring REA. The visible CL thickness difference between extremes of the imaged area was about 8% of the visible maximum thickness (10 microns at the thickest visible area, vs. 9.2 microns at the thinnest visible area). Assuming the overall sloped transition after the release of pressure was 0.1-0.2 mm long, the estimated difference of thickness between the RCA and RUA would be between 2-4 micron, which for an estimated overall CL thickness of 13 microns at the RUA, denotes an RUA/RCA thickness difference of approximately 15% to 30% of the overall CL thickness. Given that a lesser difference in thickness may be seen if a lesser pressure were applied in the pattern creation process, the RUA/RCA thickness difference may therefore vary within a larger range of 10% to 30% of the overall CL thickness.

A suitable pattern profile is selected in order not to create more cracks or pockets in CLs that may cause the localized flood under the high current density operation. Flood is a common low mass activity issue. In addition, the novel CL composition disclosed above, and the internally sub-layered structure also described above, provide a great benefit for creation of such desired external patterns than other traditional processes produced CLs. Adding post-fabrication formation of this patterned structure to some existing commercial CCM production processes of CLs is hypothesized to be of benefit to their durability as well, due to the same underlying science and engineering principles described above.

With reference to FIG. 6, application of the external CL patterning to a prefabricated MEA can be performed in matching layout to the flow field channel/rib pattern of the of the flow field plates for that MEA, which in a known manner may be bipolar flow field plates. In testing of the present invention, the external patterns in the two CLs of the MEA were created by utilizing a slightly high torque pressure on the bipolar flow field plates to compress the MEA therebetween to create the raised/uncompressed areas RUA and recessed/compressed areas RCA of the CL using the counterpart areas (flow field channels FFC and raised ribs RR, respectively) of the flow field plates. This mechanical pressing of the MEA between two flow field plates to create the external CL patterning is shown schematically in FIG. 6 by press force arrows PF denoting uniform pressure application across the MEA.

It was found that creating post patterning on a continuous CL to create compressed areas and non-compressed areas on the CL contributed to production and sustenance of an exceptional high-power density with exceptional durability. Notable differences between this post patterning and micropatterning or other alike are their characteristics listed in the following:
1) They were created by an in-vivo cell assembly. The process did not need additional expensive and precise control system to produce patterns like that used for micropatterning.
2) The process creating such pattern did not cause any potential pin holes or peeling off the nearby CL or CL materials, which were disclosed in other publications, like from Byron's group. This may be at least partly attributable to the inventive catalyst ink composition and process technology for CL fabrication.
3) More, the raised/uncompressed areas RUA of the external CL patterns in the gas flow field channels promotes a better catalytic performance due to the expanded CL thickness at these raised/uncompressed areas RUA. This improves the catalytic performance as a sustained layer pattern with controlled porous structure enhance the catalytic reactions. It is also evident in many prior publications, the CL under the flow field channels is more reactive than those under the ribs of flow field. By utilizing a correctly embedded lands in the CL through this inventive method, it provides better and more electrons to the CL areas under the channel. The conducting particles also add to this need.
4) Furthermore, the localized highly catalytic layer patterns prevent or reduce dramatically the migration of the dissolved catalytic metal ions or further restrict their re-deposition within the confined post fabrication pattern areas. This was evident that at the end of life, where the catalyst particles still distributed uniformly on the support with an increased size. The size growth of catalytical particles is mitigated by this pattern structure and assemble technique. Scientifically, the retaining of the catalytic particles on the support in the active area is one of the key factors that can promote durability.
5) The recessed/compressed areas RCA of the MEA under the raised ribs of the flow field plate cannot be void nor to be emptied without catalyst layer to avoid localized flood that will cause the adjacent area to flood too. One more aspect is not to create cracks between the RCE & RUA, as such cracks are not ideal for high performance of electrochemical application.

### 6) Added Protection of Solid Electrolyte Membrane

Solid electrolyte membrane is a critical raw material for CCM. Most commercial reinforced membranes (RIM) do not last under high power density operation in extended hours. Several factors cause the deterioration of the RIMs. The market dominant product is Gore Select RIM products. However, they are quite expensive and still suffer unceasing deterioration during the operation. The leaching of fluorine, the loss of ionomers, the attack by the hydroxyl radicals, the stress from heat or operational gaseous pressures, most of the time, the RIM thickness will appear thinning over time. Thus, the burst of the RIM will bring the end of life of CCL, as well as the stack.

It was evident from testing of the present invention that through the inventive CL structure coated on a RIM, the commercial RIM experienced much mitigated shrinking or thinning. The high-power density at the end of 150,000 cycles of testing over 0.90 watt per cm² was a solid evidence of this added protection of the RIM. The high-power density indirectly indicated that the proton conductivity of RIM was excellent at the end of life of the tested CCM.

High resolution imaging, taken with a scanning electron micrograph [FIG. 10], of the inventive CCM after testing showed less than 8% of thickness loss. Comparing to the CCM at BOL, its thickness was average of 12 micron (±1 micron). It was 11 micron ((±1 micron) at EOL.

The cross section of the CCM at EOL is shown in FIG. 8. The dense layer (Pt concentrated band) on the PEM side is shown to have a thickness 3.2 (±1.0) micron. The average thickness of the catalyst layer was about 9.6 micron. The thickness of the used commercial PEM was at 15.0 micron, which is in excellent agreement with that of the product before it was coated. The top/outermost sublayer of the CL was not observed clearly, as it was intended not to create a dense packing of notable thickness, but rather to smooth the rough surface of the more loosely packed middle/intermediate layer, and thus prevent the peeling of any catalysts or bare support particles.

Such results indicate excellent potential to reduce the CCM cost by utilizing no specialty RIM for the same application.

### EXAMPLES

### Example 1: The Inventive Ink Formulation

A platinum containing catalyst was selected based on its ECSA and catalytical size distribution. For example, a carbon supported catalyst containing 20% to 50% or higher Platinum content can be selected as a first portion of catalyst. This catalyst was homogenized with a solvent solution by a known process, including jar milling over night. For example, 1.0 gram of Pt-/C catalyst was used in a solution mixed with alcohol and water to form a homogeneous solution by jar milling. The volume of solvent system was determined by the coating process based on the required viscosity or solid content. For example, for the above amount of catalyst, a volume of alcohol solution was between 40 to 70 ml. Though micro-fluidization, or ultrasonication could instead be employed. This homogenized catalyst ink solution 1 was mixed with a desired amount of binder, in this case a Nafion ionomer, to form an ionomer-coated catalyst ink solution (Catink1). The amount of ionomer used may vary, for example between 20% to 90% of the amount of the conductive support of the catalyst. The amount of the binder selected may be based on the type of catalyst layer in accordance with its intended application. In this example, a ratio of 70% ionomer to conductive catalyst support was used.

A second portion of the catalyst, which may have the same or different ratio of catalyst to support content relative to the first portion, was measured and homogenized in an alcohol solution to derive a binder-free catalyst ink solution (Catink2). In this particular example, an equal amount of the selected catalyst nanoparticles was used as for Catink1.

Then, the Catink1 was added slowly into Catink2 with a rigorous stirring, thereby deriving a catalyst ink mixture (Catink3), which was stirred over time before use. A portion of the Catink3 was used directly to fabricate the inventive catalyst layer.

A binder-free support ink (Supink1) comprising a bare conductive support, such as carbon support nanoparticles, in a solvent solution was then prepared, and homogenized before use by an ultrasonication means. The amount of the bare support particles was calculated based on the total catalyst product(s) that were used in the two catalyst inks (Catink1, Catink2). The ratio between the support and the catalyst is preferably less than 1, and even more preferably is less than 0.5. For the above sample, 0.80 gram of conductive carbon in 50 ml alcohol solution was used for Supink1. The Supink1 was further homogenized in the same solvent system with ultrasonication for certain period like up to one hour before adding Supink1 slowly into the Catink3 with a rigorous stirring. After the mixing, the resulting final catalyst layer ink mixture was stirred over at least one hour before use.

If a high-power fluidizer was employed, the Catink1 mixing time can be shortened greatly. Same is true for the catalyst homogenization with a selected solvent solution with high-power fluidizer equipment.

### Example 2: An Alternative Inventive Ink Formulation

In Example 1, if the catalyst used in Catink1 and Catink2 were same, a large portion of the same catalyst can be used in the first ink solution preparation. Then, after homogenization, the ink solution was divided into two portions. The smaller portion was added a desired amount of ionomer solution to form Catink1. The residual ink without ionomer to form Catink2. After the Catink1 was stirred over night, it was added into Catink2 slowly to form the Catink3. The Supink1 was prepared by the same method described in Example 1. After ultrasonication of Supink1, it was added slowly into Catink2 to form the final ink solution, which was stirred over at least one hour before use.

### Example 3: The Inventive Manufacture of the Inventive CCM Product

The above produced ink from Example 1 was transferred to a coating machine. The inventive multi-layered CCM structure was fabricated by the following process with an ultrasonic spray coater. However, this process can alternatively be executed using known process technologies including slot die coating, and other doctor-blade coating, or even screening print technique, or any multilayer coating process.

The material packing densities of different sublayers were denoted as MPD1 for the innermost sublayer, and MPD2 for the outmost sublayer. Labeling format MPD-I # is used for the intermediate sublayer(s), where # is a numerical identifier for different sublayers within the intermediate layer. For example, MPD-i1 and MPD-i2 denote the respective packing densities of two different intermediate sublayers. For general purposes, the values of MPD1 and MPD2 are typically be greater than that of MPD-i #.
Step 1). A clean membrane, for example a Nafion membrane or other reinforced proton exchange membrane, was laid on a hotplate with a temperature set below the gasification temperature of membrane to reduce the swelling of the membrane during the coating. A thin layer of the solid content of the ink was fabricated atop the membrane by controlling the coating parameters, for example, including the flow rate, the shaping air pressure, hotplate temperature, and the sonication frequency and power of an ultrasonic spray coater. As ultrasonic spray coating is a well-known coating process technology, suitable optimization of the process parameters to achieve the desired results described herein will be apparent to those of ordinary skill in art. Obtaining different size of the atomized droplets is achievable by controlling a set of the coating parameters for each layer. Preferably, such control is used to achieve semi-dried or dried solid particles with a desired MPD1. In this ink sample, the size of such deposited particles was in the range of 50-150 nm. This first layer was fabricated using about 10-30% of the total ink volume for the catalytic layer. For this example, an innermost sublayer thickness of about 30% of the total catalyst layer was fabricated using the above disclosed ink solution. A dense bottom/innermost sublayer was thereby produced, whose thickness can vary depending on the solid content of the ink and the design of the CL.
Step 2). The second layer was coated on top of the first layer immediately, using an increased flow rate, and associated adjustment of other coating process parameters to obtain a desired droplet size and wetness. The flow rate was increased to more than the initial flow rate to produce the large, agglomerated particles in the CL, creating an intermediate sublayer of lesser material packing density than the prior sublayer. The dried solid particles had a size range from about 80 nm to about 500 nm. Uniformly large agglomerated particles are more preferable. This intermediate sublayer shall contain about 50-70% of total ink volume for the desired CL in select embodiments. For this example, the intermediate sublayer's thickness was about 5 to 6 microns. In addition, it was known that a large swelling of the membrane by solvent(s) during the coating process was not ideal for high performance CCM. Most droplets were controlled to reach a semi-wet status before they deposited the membrane. For any skilled in art, manipulation of the coating parameters could achieve this requirement easily.
Step 3). A third layer was produced on top of the second layer. The flow rate was changed to a smaller one in order to produce a compact and dense top/outermost sublayer with a smooth surface. Other coating process parameters were adjusted to produce the needed top layer with uniform coverage and thickness.
Step 4). When one catalyst layer with three layers was finished on a first side of the membrane, the catalyst coated membrane was flipped over and the same coating process from steps 1)-3) was repeated to prepare the other CL on the opposing side of the membrane.

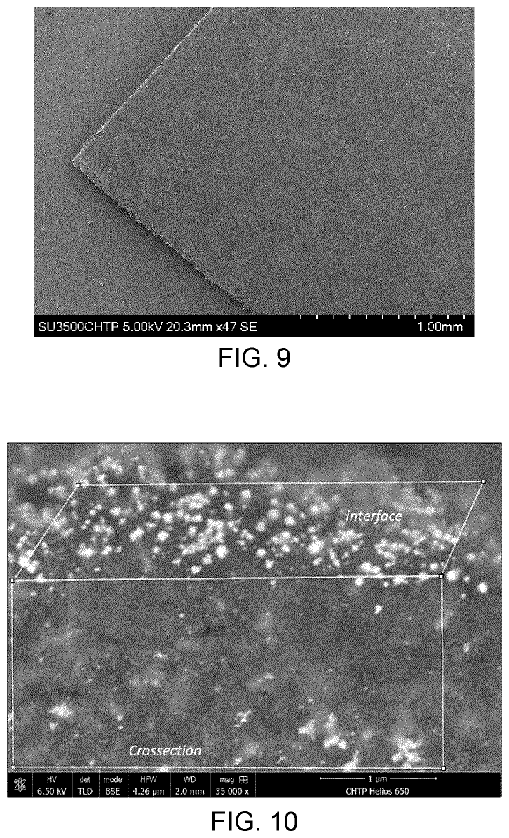

Through performance of this novel combination of process steps, an inventive CCM with an inventive CL composition was prepared, for subsequent testing. FIG. 9 shows a top-view SEM image of the CCM, which shows a uniform and smooth top surface morphology. Such a top/outermost sublayer is ideal as no cracks were observed, nor were any loose islands or packed large agglomerates exposed. The uniform pores throughout the coated electrode were also ideal pathways for gas diffusion and escape of liquid (e.g. water, in the case of).

### Example 4: The Making of a Membrane Electrode Assembly

A membrane electrode assembly with active area of 50 cm² (50.0 mm in width and 100.0 mm in length) was fabricated according to the following procedure.

A piece of the fabricated inventive CCM above was cut to a preferred size to be sandwiched between two gas diffusion layers. Normally, the CCM is cut to 70 mm in width, and 120.0 mm in length. Two pieces of rectangular GDLs were cut to 58×108 mm in dimension. This set of electrodes was laminated between two pieces of plastic films with glue on one side, which has an open area of 50 mm by 100 mm aligned and centered exactly on top of the cut CCM. Then, the final MEA product was hot pressed at 115 degrees Celsius for 3-8 minutes under a sufficient pressure to provide leak-proof sealing of the MEA.

The leak testing was done after the MEA is assembled in a mono-cell stack. The stack was applied with 5 PSI compressed air on each gas inlet with a switch valve closed on each outlet. The cell was immersed in a water container to observe any bubbles appear from the center. The leak test of the MEA was done by pressurizing only one side of the MEA at 5 PSI and check whether any gas came out from the opposite side of MEA gas channel, the outlet.

### Example 5: Fabrication of External Patterns on CCM

The external patterns of the catalyst coated membrane were produced simultaneously by compressing the MEA between two flow field plates on both sides at sufficient pressure. For example, the above fabricated MEA was placed in two graphite made flow field plates and compressed to achieve the compressed area depth listed above.

The lands (RUAs) and valleys (RCAs) can be seen on top of the CCM after removing the GDL. FIG. 7 show a top-view SEM image of such CCM created by the above method. The lengths of line 1, 2, 3, and 4 are 1.00, 0.92, 1.06, and 0.90 mm, of which lines 1 and 3 are measurement lines spanning across RCA, and lines 2 and 4 are measurement lines spanning across RUA. They are in good agreement with that of the flow field with channel width at 1.0 mm and land width at 0.90 mm. The broadening could be caused by the elastic compression of the GDL between the flow field and the CCM.

The Testing of the MEA with Inventive CCM This finished MEA was subjected to an activation process in a fuel cell test station with 100% RH and at 80° C. with hydrogen as fuel and air as oxidant. After the activation process, the MEA was subjected to polarization tests by following the testing program.

Then the MEA was subjected to HDV DOE MEA testing protocol published in November 2019. Basically, the MEA was subjected to CV cycling between 0.6 to 0.95 V with 50 mV/sec for a total of 150,000 cycles at 85° C., 100% relative humidity, and under 1 bar each side. At each 1000 or 3000 cycles, the ECSA measurement was performed and recorded. At each 5000 cycles, the polarization curve was measured under hydrogen and air at 85° C. and 100% relative humidity. Then the cell was purged with nitrogen on cathode sufficiently, and durability test was continued until it reached 150,000 cycles.

The cell voltage at 1.0 A/cm² and 1.5 A/cm² are summarized at different number of cycles in FIG. 4. The results showed that over 150,000 cycles were performed under the testing protocol of DOE HDV MEA published in November 2019. The voltage change at power density of 1.5 A/cm² was at 5.0%, which is at half of the benchmark of the requirement of MEA performance for HDV application.

### Example 6: The Making of Pt Thin Film Coated Supported Catalysts

When an inventive CL of the type disclosed above was prepared and tested under CV cycles with a setting in which hydrogen gas was feeding on the anode side, and nitrogen was feeding on the cathode side at 60 to 80 degrees Celsius, and a selected relative humidity between 80% to 100%, through a sufficient quantity of cycles, for example more than 50,000 cycles at 50 mV/sec, the ECSA of the CL was reduced about 20%. When the MEA was cycled over 100,000 cycles, the ECSA was reduced by about 28% of the initial value. And when the MEA was cycled over 150 k, the ECSA was reduced by about 40% of the initial value. It was believed that the inventive Pt thin film covered supported catalysts were formed gradually during this period. The presence of various size Pt thin film coated nanoparticles and agglomerates within the CL supports strongly for the production progress over the time. The highly concentrated Pt content in the innermost region of the CL (close to the membrane) and very poor Pt content in the adjacent region is the other solid evidence of the progressive production of Pt thin film coated nanoparticles.

The resulting Pt coated nanoparticles are observable in FIG. 10 as bright spots in the image. Particles of similar brightness particles are observable within the intermediate sublayer as well, though in lesser quantity and concentration.

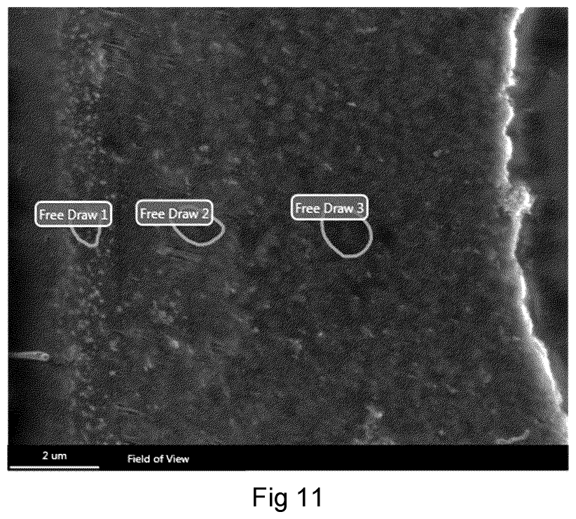

With reference to FIG. 11, the Pt content in different areas analyzed by Electron Dispersive X-ray spectroscopy were obtained as follows: in the freedraw region 1, Pt content was 39.0%; in the freedraw2, Pt content was 34.9%; in the freedraw region 3, Pt content was 14.9%. Other than this analyzed Pt content, the remaining mass was predominantly carbon.

Since various modifications can be made in my invention as herein above described, and many apparently widely different embodiments of same made, it is intended that all matter contained in the accompanying specification shall be interpreted as illustrative only and not in a limiting sense.

### REFERENCES

1. Jian Xie, Journal of The Electrochemical Society, 151 (11), A1841-46, 2004
2. Jung, W. S., Study on durability of Pt supported on graphitized carbon under simulated start-up/shut-down conditions for polymer electrolyte membrane fuel cells, Journal of Energy Chemistry (2017)
3. Natalia Macauley et all 2018, J. Electrochem. Soc. 165 F3148, “Carbon corrosion in PEM fuel cells and the development of Accelerated stress Tests”
4. Elliot Adgett et al 2019 J. Electrochem. Soc. 166 F198, “Mitigation of PEM Electrochemical catalyst degradation with Porus Carbon Supports
5. Borup, R et al 2020 Current Opinion in Electrochemistry, “Recent developments in catalyst-related PEM electrochemical durability”
6. DeBruijn, F. A., et al 2008, Fuel Cells, 08, No. 1, Page 3-22
7. Wang, Y., et al, Applied Energy, 2011, Page 981-1007, “A review of polymer electrolyte membrane fuel cells: Technology, application, and needs on fundamental research”
8. Wang, H. J., et al, Journal of Power Sources, 2011, 196, 9107-9116, “A review of polymer electrolyte membrane electrochemical durability rest protocols”
9. Hu, X., Song, K., NIU, W., and Zhang, T., “Powertrain System Durability in Proton Exchange Membrane Electrochemical Electric Vehicles: A Review,” SAE Technical Paper 2018-01-1303, 2018
10. Mohammed J. et al, international journal of engineering science and advanced Technology, 2017, V7, Issue 1, 100-107
11. Qin, C. W., et al Catalysts, 2016, 6, 197, “Proton Exchange Membrane Electrochemical reversal: A review
12. Ascarekku P., et al, Journal of Applied Physics 91, 4556 (2002); doi: 10.1063/1.1453495,” Formation process of nanocrystalline materials from x-ray diffraction profile analysis: Application to platinum catalysts
13. Z. Siroma et al./Electrochemistry Communications 7 (2005) 1153-1156, “Imaging of highly oriented pyrolytic graphite corrosion accelerated by Pt particles.
14. Willisau, J, Heitbaum, J. Electroanal. Chem., 161 (1984) 93-101, “The Influence of Pt activation on the corrosion of carbon in gas diffusion electrodes—a DEMS study”
15. Chong et al., Science 362, 1276-1281 (2018), “Ultralow loading Platinum-cobalt fuel ell catalysts derived from imidazolate frameworks.
16. Schuler, T., Journal f The Electrochemical Society, 166 (7), F3020-3031 (2019)
17. Gates, 2020, ACS Journal of applied energy materials, 202, 3, 1, 478-486
18. Accelerate Stress Testing protocol for HDV MEA by Department of Energy of the United States.

1. A catalyst layer composition comprising:
binder-coated nanoparticles coated with a binder as a binding base;
binder-free catalyst nanoparticles attached to at least said binder-coated nanoparticles at the binding base thereof; and
orderly electric, ionic, gas and liquid pathways within the layer that are at least partially defined by interconnections between the binder-coated nanoparticles and said binder-free catalyst nanoparticles.

2. The catalyst layer composition of claim 1 further comprising binder-free electrically conductive support nanoparticles that are attached with either or both of said binder-free catalyst nanoparticles and said binder-coated nanoparticles to form said orderly electric, ionic, gas and liquid pathways within the layer

3. The catalyst layer composition of claim 2 wherein the binder-free electrically conductive support nanoparticles are non-catalytic conductive particles.

4. The catalyst layer composition of claim 1, wherein the binder-coated nanoparticles are electrically conductive.

5. The catalyst layer composition of claim 1, wherein the binder comprises a solution soluble ionomer.

6. The catalyst layer composition of claim 1, wherein the binder comprises a solution dispersible binder of high-temperature capability able to withstand operating temperatures in excess of 100 degrees Celsius.

7. The catalyst layer composition of claim 1, wherein the binder-coated nanoparticles include binder-coated catalyst nanoparticles.

8. The catalyst layer composition of claim 7, wherein both the binder-coated catalyst nanoparticles and the binder-free catalyst nanoparticles are supported catalyst nanoparticles having an electrically conductive support.

9. The catalyst layer composition of claim 1, wherein the binder-coated nanoparticles are non-catalytic nanoparticles.

10. The catalyst layer composition of claim 1, wherein the binder-free catalyst nanoparticles include supported catalyst catalytic nanoparticles having an electrically conductive nanosized support.

11. The catalyst layer composition of claim 1, wherein the binder-coated nanoparticles and the binder-free catalyst nanoparticles include agglomerated nanoparticles, and have a particle size ranging from 30 nanometers (nm) to 2500 nm.

12. The catalyst layer composition of claim 11, wherein said binder-free catalyst nanoparticles also include non-agglomerated nanoparticle, whose particle size is less than 100 nm.

13. The catalyst layer of claim 1, wherein the orderly electric, ionic, and gas and liquid pathways are composed of connected pores within, or among, agglomerates of catalyst particles.

14. The catalyst layer of claim 1, wherein said binder free catalyst nanoparticles are selected from the group consisting of chromium, iron, copper, nickel, cobalt, yttrium, zirconium, niobium, molybdenum, ruthenium, rhodium, palladium, silver, indium, tin, barium, hafnium, tantalum, rhenium, osmium, iridium, platinum, gold, lead, bismuth, lanthanum, samarium, and combinations or alloys or metal oxides thereof.

15. A solid-state electroplating method of producing a catalytic material thin film coated support catalyst product comprising nanosized electrically conductive solid nanoparticles and a thin film of catalytic material deposited on surfaces of said electrically conductive solid nanoparticles, said method comprising:
possessing an electrode whose catalyst layer that comprises the electrode catalyst layer composition of claim 1; and
subjecting said electrode to an electrochemical reaction during which catalytic nanoparticles in the catalyst layer are redistributed to form said thin film of catalytic material on said nanosized electrically conductive solid nanoparticles.

16. The method of claim 16 wherein said electrochemical reaction is carried out in a fuel cell reactor.

17. The method of claim 15 wherein the electrode is a cathode of said fuel cell reactor.

18. The method of claim 15 wherein the catalyst layer is a multi-layered catalyst layer comprising a plurality of sublayers layered overtop of one another, said plurality of sublayers including:
a) an innermost sublayer characterized by a first material packing density;
b) an outermost layer residing oppositely of said innermost layer and characterized by a second material packing density; and
c) one or more intermediate sublayers residing between said innermost sublayer and said outermost sublayer, and each characterized by a respective material packing density that is different from that of said first or second material packing densities.

19. The method of claim 18, wherein the material packing density of each intermediate sublayer is lesser than that of at least one of the innermost and outermost sublayers.

20-27. (canceled)

28. A catalytic material thin film coated support catalyst product produced in accordance with claim 15.

29-68. (canceled)
